(19) United States
(12) Patent Application Publication
(10) Pub. No.: US 2003/0202740 A1
(43) Pub. Date: Oct. 30, 2003

(54) Optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/295,158

(22) Filed: Nov. 14, 2002

(30) Foreign Application Priority Data
Apr. 25, 2002 (TW) 91205687

(51) Int. Cl. G02B 6/35; G02B 6/32

(52) U.S. Cl. 385/22; 385/33

(57) ABSTRACT

An optical switch includes an input port (20) having an input fiber (201), an output port (30) having a plurality of output fibers (3011), a switching element (40), a driving device (60) and a base (50). The input port, the output port and the driving device are mounted on the base. The switching element has a plurality of prisms for switching light beams from the input fiber to the different output fibers. Each prism can be moved into an optical path between the input and output fibers, and can deflect the light beams from the input fiber in different direction, thereby, switching the input light beams to different, predetermined output fibers.

### BACKGROUND OF THE INVENTION

1. Field of the Invention

The present invention relates to an optical switch for use in optical communication and optical network technology, and particularly to a mechanically operated optical switch with a plurality of prisms as a switching element. A copending application having the same filing date, the same title, the same applicant and the same assignee with the invention is referenced hereto.

2. Description of Related Art

Optical signals are commonly transmitted in optical fibers, which provide efficient light channels through which optical signals can pass. Recently, optical fibers have been used in various fields, including telecommunications, where light passing through an optical fiber is used to convey either digital or analog information. Efficient switching of optical signals between individual fibers is necessary in most optical processing systems or networks to achieve the desired routing of the signals.

Various optical fiber systems, employing different methods, have been previously developed for switching optical signals between fiber cables. Among these previously developed systems, one important category is mechanical optical switches.

Mechanically operated optical switches come in two different designs: in one design, the optical components move, and in the other design, the fibers move. Factors for assessing the capability of an optical switch include low insertion loss (<1 dB), good isolation performance (>50 dB) and bandwidth capacity compatible with the fiber network.

Moving fiber switches involve the actual physical movement of one or more of the fibers to specific position to accomplish the transmission of a light beam from one fiber end to another under selected switching conditions. Moving optical component switches, on the other hand, include optical collimating lenses which expand the light beam coming from the fibers, and moving prisms or mirrors which redirect the expanded light beam to other fibers, as required by the switching process.

The moving fiber switches have a stringent tolerance requirement for the amount and direction of fiber movement. The tolerance is typically a small fraction of the fiber core diameter for two fibers to precisely align to reduce losses. The fibers themselves are quite thin and may be subject to breakage if not properly protected. On the other hand, reinforcing the fibers with stiff, protective sheaths makes the fibers less flexible, increasing the force required to manipulate each fiber into alignment. Thus, these moving fiber switches share a common problem of requiring high precision parts to obtain precise position control and low insertion loss. This results in high cost and complicated manufacture of the switches. Moreover, frequently moving fibers to and fro is apt to damage or even break the fibers.

The moving optical component switches, in contrast, have less stringent movement control tolerance requirements. The presence of collimating lenses allows relaxation of the tolerance requirements.

FIG. 8, shows a shifted optical fiber type switch as disclosed in U.S. Pat. No. 4,146,856. This optical switching device comprises an envelope 10, a pair of magnetically permeable reed arms 111, 112, three support members 121, 122, 123, and three optical fibers 131, 132, 133. The reed arms 111, 112 are mounted to opposite ends (not labeled) of the envelope 10. The reed arms 111, 112 respectively extend into the envelope 10 and overlap each other at inner ends (not shown) thereof. The support member 121 defines a bore 124, and is attached to a top of the end of the reed arm 112. The support member 122 defines a bore 125, and is attached to an inner wall of the envelope 10. The support member 123 defines a bore 126, and is mounted to the end of the reed arm 111 such that it generally opposes the support member 121. The three optical fibers 131, 132, 133 extend through the ends of the envelope 10, and are respectively secured in the bores 124, 125, 126 of the support members 121, 122, 123. When the reed arms 111, 112 are magnetized such that they have opposite polarities, they abut against each other. The optical fiber 131 is thus aligned with optical fiber 133. When the reed arms 111, 112 are magnetized such that they have the same polarity, they repel each other such that the support member 121 abuts against the inner wall. The optical fiber 131 is thus aligned with the optical fiber 132. In this way, optical transmission paths can be switched. However, a misalignment can often occur when the position of the moveable optical fiber 131 changes too frequently. Misalignment increases optical loss and reduces the quality of the transmitted light.

As illustrated in FIG. 9, U.S. Pat. No. 5,420,946 describes an optical coupling switch for coupling light beams from an input port 14 into a selected output port 16. The input fiber 141 is optically aligned with one of a plurality of output fibers 161 via a switching element 15. By rotating the reflector 152 attached to a block 151 of the switching element 15 about an axis 153, the input light beam can be reflected to a selected output fiber 161. The input fiber 141 and all the output fibers 161 are in fixed positions relative to each other.

In this mechanical switch, the plurality of output fibers 161 are separately mounted on a platform, which makes the structure of the switch complex, the size large, and the aligning process between the input fiber 141 and the plurality of output fibers 161 involved. In addition, the mechanical switch uses a plurality of GRIN lenses 162, 142 on front ends of the output fibers 161 and the input fiber 141 to collimate the light beams, which adds greatly to the cost of the mechanical switch.

For the above reasons, an improved optical switch is desired. In particularly, an optical switch is desired which has low cost, high optical efficiency and which does not require precise alignment or movement of the optical fibers themselves.

### SUMMARY OF THE INVENTION

An object of the present invention is to provide an optical switch in which the optical fibers don't move.

Another object of the present invention is to provide an optical switch which has low cost and small size.

An optical switch comprises an input port having an input fiber, an output port having a plurality of output fibers, a switching element having a plurality of prisms for switching light beams from the input optical fiber to the different output fibers, a driving device, and a base for mounting the input port, the output port and the driving device thereon.

Input light beams from the input optical fiber transmit through a first collimating lens of the input port, which collimates the dispersed input light beams to parallel light beams. The parallel light beams pass through one predetermined prism of the plurality of prisms and are refracted by the prism in a predetermined direction. The refracted light beams then pass through a second collimating lens of the output port, which converges the light beams into one predetermined output optical fiber. Each prism can sequentially be moved into the optical path of the light beams between the input and output optical fibers. Each different prism deflects the light beams from the input optical fiber in a different direction, thereby, switching the input light beams to different output fibers.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an optical switch according to the present invention;

FIG. 2 is a schematic, cross-sectional view taken along the line 2-2 in FIG. 1;

FIG. 3 is a schematic, cross-sectional view taken along the line 3-3 in FIG. 1;

FIG. 4 is a schematic, cross-sectional view taken along the line 4-4 in FIG. 3;

FIG. 5 is a schematic, cross-sectional view taken along the line 5-5 in FIG. 4, without a quartz sleeve and a metal tube;

FIG. 6 is a schematic, cross-sectional view taken along the line 6-6 in FIG. 5;

FIG. 7 is an essential optical paths diagram of the optical switch in FIG. 1;

FIG. 8 is a schematic diagram of a prior art optical switch; and

FIG. 9 a perspective view of another prior art optical switch.

### DETAILED DISCLOSURE OF THE INVENTION

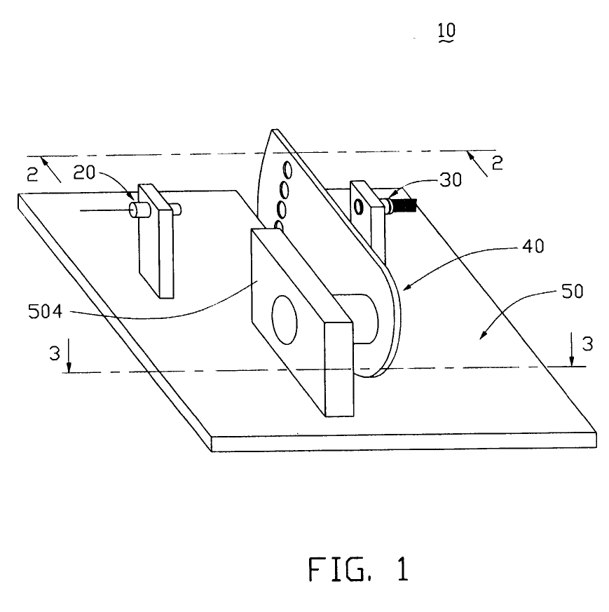

Referring to FIG. 1, an optical switch 10 comprises an input port 20, an output port 30, a switching element 40, a driving device 60 and a base 50 for mounting the input port 20, the output port 30 and the driving device 60 thereon.

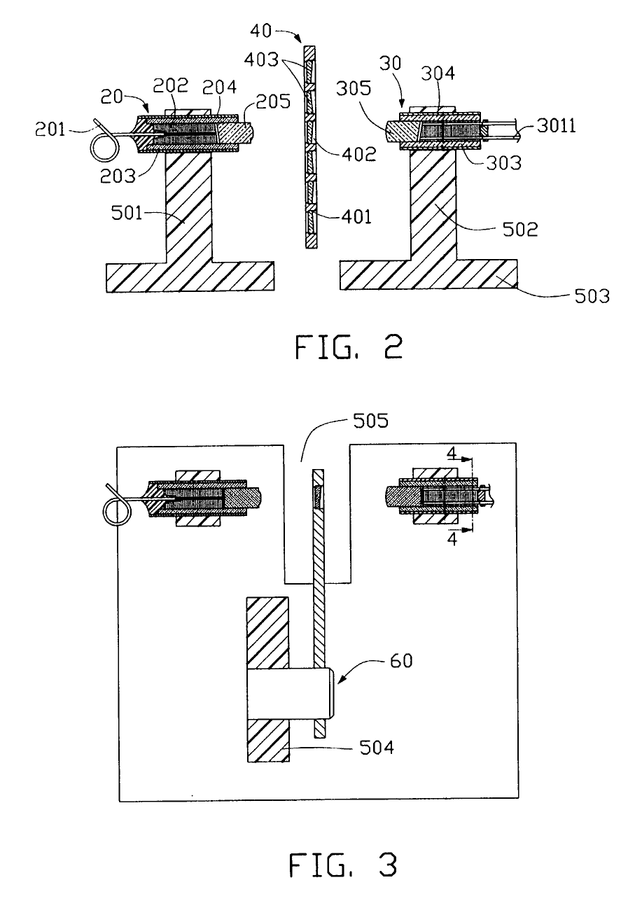

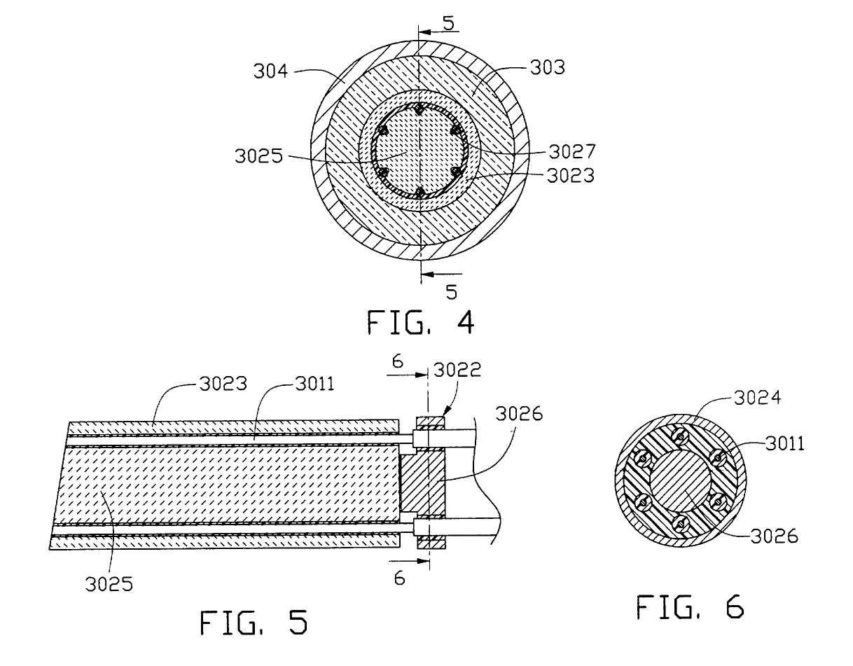

As shown in FIGS. 2 and 3, the base 50 has a substrate 503 and three upright beams 501, 502, 504 extending upwardly from the substrate 503. An opening 505 is defined in the substrate 503 between the two upright beams 501, 502. The upright beams 501, 502 are opposite one another for alignment of the input port 20 and the output port 30.

The switching element 40 comprises a prism assembly 403 mounted in a holder 401. The holder 401 defines a plurality of hollowed out mounting holes 402 extending therethrough. The plurality of mounting holes 402 is arranged in an arc-shaped line, and each prism of the prism assembly 403 is accommodated and fixed in a corresponding mounting hole 402 by epoxy resin. Each prism has a first planar end face (not labeled) which makes an angle with a plane defined perpendicular to an optical axis, the optical axis being coaxial with the input port 20 and the output port 30. The first planar end face opposes the output port 30. A second planar end face (not labeled) of the prism is perpendicular to the optical axis, said second planar end face opposing the input port 20. The prism assembly 403 can instead be a lens assembly.

The input port 20 comprises an input fiber 201, a ferrule 202, a first collimating lens 205 aligning with the ferrule 202, and a quartz sleeve 203 receiving the first collimating lens 205 and the ferrule 202 therein. The ferrule 202 defines a through hole (not labeled), which accommodates an exposed portion of the input fiber 201. The input fiber 201 is fixed in the through hole (not labeled) with epoxy resin. The first collimating lens 205, which can be a molded lens having a single index, partially extends out of the quartz sleeve 203. The input port 20 further has a metal tube 204 surrounding the quartz sleeve 203 for protecting the input port 20.

Referring to FIGS. 4˜6, the output port 30 has a multi-fiber ferrule (not labeled), a plurality of output fibers 3011, a second collimating lens 305, a fiber holder 3022 and a quartz sleeve 303. The multi-fiber ferrule comprises a core 3025 and a sleeve 3023 surrounding the core 3025. A plurality of grooves 3027 are defined, evenly spaced apart, in an exterior surface (not labeled) of the core 3025. Each output fiber has an exposed end portion which is mounted in a corresponding groove 3027 of the multi-fiber ferrule. The second collimating lens 305 has a single index and aligns with the output fibers 3011. The fiber holder 3022 comprises a ring 3024 and a support portion 3026, with an annular space (not labeled) formed therebetween to receive and fix the fibers 3011 using epoxy resin. The fiber holder 3022 is attached to the multi-fiber ferrule. The quartz sleeve 303 receives and fixes the multi-fiber ferrule and the second collimating lens 305. The second collimating lens 305 is a molded lens and partially extends out of the quartz sleeve 303. The output port 30 further has a metal tube 304 surrounding the quartz sleeve 303 for protecting the output port 30.

In assembly, the input port 20, the output port 30 and the driving device 60 are mounted on the upright beams 501, 502, 504, respectively. The two upright beams 501, 502 are parallel, and the two input and output ports 20, 30 are coaxial with each other. The holder 401 of the switching element 40 is connected with the driving device 60 and is arranged between the two input and output ports 20, 30. The prism assembly 403 aligns with the two input and output ports 20, 30.

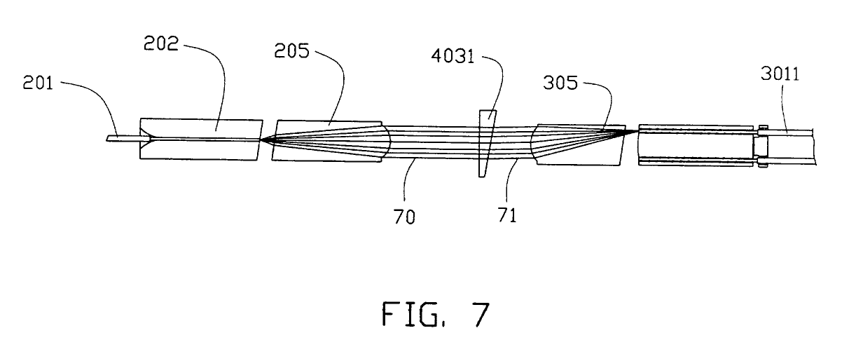

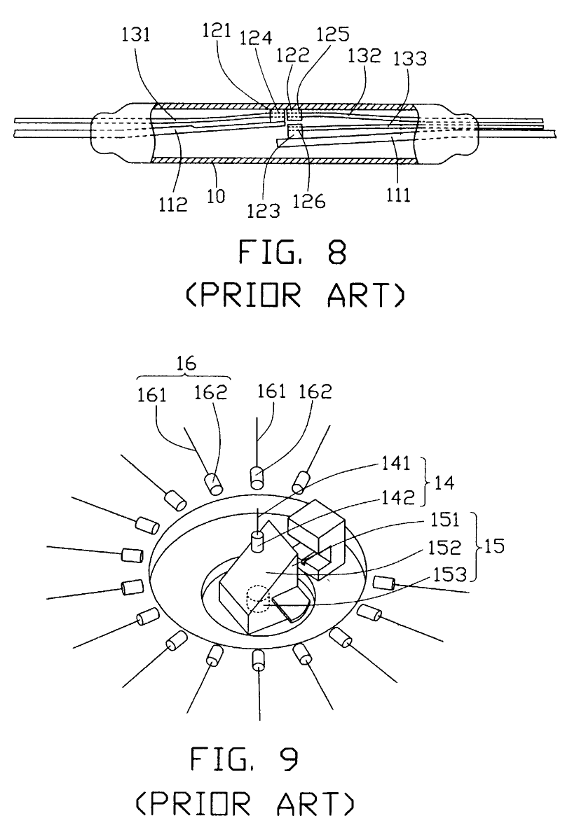

FIG. 7 shows an essential optical paths diagram of the optical switch. Input light beams from the input fiber 201 transmitting through the first collimating lens 205, which collimates the dispersed input light beams to parallel light beams 70. The parallel light beams 70 then pass through a prism 4031 of the prism assembly 403, which refracts the parallel light beams to 70 in a predetermined direction. The parallel light beams then pass through the second collimating lens 305, which focuses the light beams into one predetermined output optical fiber 3011.

When the switching element 40 is driven to rotate, thereby, other prisms of the prism assembly 403 can sequentially align with the optical path. The refracted input light beams transmitted through a different prism are deflected to a different output optical fiber 3011.

Advantages of the optical switch 10 of the present invention over those of the prior art include the following. First, only optical components of the switch move; no fibers move. Second, using a ferrule to accommodate a plurality of optical fibers decreases the size of the switch and lessens its costs, rather than the large size and high cost of the prior art design having separate output optical fibers with a plurality of GRIN lenses. Thus, the cost and the size of the design of the present invention are minimized.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical switch for switching light beams from one input optical fiber between a plurality of output fibers, comprising:
a first collimating lens aligning with the input fiber and collimating input light beams;
a second collimating lens aligning with the output fibers and collimating output light beams, the output fibers being mounted in a multi-fiber ferrule;
a switching element being arranged between the first and second collimating lenses, and the switching element comprising a plurality of prisms; and
a driving device driving the plurality of prisms to rotate, moving individual prisms sequentially into an optical path between the input fiber and the output fibers, each prism deflecting the light beams from the input fiber to a different predetermined output fiber;
wherein the multi-fiber ferrule comprises an inner core and a sleeve, and the output optical fibers are evenly spaced around the inner core and are fixedly secured between the inner core and the sleeve.

2. The optical switch as claimed in claim 1, wherein the multi-fiber ferrule defines a plurality of evenly-spaced grooves in an exterior surface of the inner core, and the plurality of output fibers are mounted in the grooves, respectively, and the sleeve surrounds the core to stably mount the output fibers in the grooves.

3. The optical switch as claimed in claim 1, further comprising a metal tube and a quartz sleeve, the quartz sleeve surrounding and fixing the multi-fiber ferrule and the second collimating lens therein, and metal tube surrounding and fixing the quartz sleeve therein.

4. The optical switch as claimed in claim 1, further comprising a ferrule holding the input fiber, a metal tube and a quartz sleeve, the quartz sleeve surrounding and fixing the ferrule and the first collimating lens therein, and metal tube surrounding and fixing the quartz sleeve therein.

5. The optical switch as claimed in claim 1, wherein the first and second collimating lenses are molded lenses with a single index.

6. The optical switch as claimed in claim 1, wherein the switching element further comprises a holder with a plurality mounting holes for accommodating and fixing the prisms therein.

7. The optical switch as claimed in claim 1, wherein each prism has one planar end face, the plane of which makes an angle with a plane constructed normal to the optical path.

8. An optical switch for switching light beams from one input optical fiber between a plurality of output fibers, comprising:
a first collimating lens aligning with the input fiber and collimating an input light beam;
a second collimating lens aligning with the output fibers and collimating output light beams, the output fibers being mounted in a multi-fiber ferrule;
a switching element being arranged between the first and second collimating lenses, and the switching element comprising a plurality of prisms which are mutually exclusively rotatably located to a specific position where a light path from the input light beam is directed to the predetermined output light beams, respectively; and
wherein the multi-fiber ferrule comprises an inner core and a sleeve, and the output optical fibers are evenly spaced around the inner core and are fixedly secured between the inner core and the sleeve.

9. An optical switch for switching light beams from one input optical fiber between a plurality of output fibers, comprising:
a first collimating lens aligning with the input fiber and collimating an input light beam;
a second collimating lens aligning with the output fibers and collimating output light beams, the output fibers being mounted in a multi-fiber ferrule;
a switching element being arranged between the first and second collimating lenses, and the switching element comprising a plurality of prisms which are mutually exclusively rotatably located to a specific position where a light path from the input light beam is directed to the predetermined output light beams, respectively; and
wherein the multi-fiber ferrule comprises a core only supporting bared fibers, and a support portion located axially outside of the core supporting the jacketed fibers.
